(19) United States
(12) Patent Application Publication
(10) Pub. No.: US 2004/0172447 A1
(43) Pub. Date: Sep. 2, 2004

(54) Systems and methods for managing data

(76) Inventor: Dale Christopher Miller, Clemmons, NC (US)

Correspondence Address: Charles W. Calkins, Esq., Kilpatrick Stockton LLP, 1001 West Fourth Street, Winston-Salem, NC, 27101, US

(21) Appl. No.: 10/757,135

(22) Filed: Jan. 14, 2004

Related U.S. Application Data
(60) Provisional application No. 60/439,976, filed on Jan. 14, 2003.

(51) Int. Cl. G06F 15/16

(52) U.S. Cl. 709/203

(57) ABSTRACT

A personalized and privatized method for the composition, distribution and ongoing data management of patient and practitioner surveys or diaries and other key information related to drug and medical clinical trials. The method is composed of a host data management system to manage and distribute standard or custom survey question sets and other information (such as schedules, instructions, and prescribed protocols) and two-way pagers “clients” utilizing custom resident software. The software residing on the two-way pager enables the pagers to receive, format and then transmit responses to survey and diary question sets and other interactions back to the host data management system via a page(s). The two-way pager provides a convenient and completely independent, mobile assessment capability that is able to immediately record and transmit results and interactions back to a data management system for storage, analysis, and auditing.

This invention relates to the field of wireless mobile communications, in particular to two-way pager devices or other mobile devices with an operating system (where an operating system can provide the capability to interpret and perform a set of logical codified instructions that are developed for a specific purpose), and more particular to the use of these devices in a unique application.

### STATEMENT OF RELATED APPLICATIONS

This application claim priority under 35 USC 119 from U.S. provisional patent application Ser. No. 60/439,976, filed Jan. 14, 2003, the disclosure of which is hereby incorporated herein by reference.

### FIELD OF THE INVENTION

The present invention relates to systems, methods and computer readable media relating to data creation, collection, distribution, management and/or analysis. In an embodiment the present invention more particularly relates to systems, methods and computer readable media for creating, collecting, distributing, managing and/or analyzing data utilizing computer and communications networks. One embodiment of the present invention is particularly advantageous for creating, collecting, managing, analyzing and/or presenting data from patients during clinical trials of new pharmaceuticals, medical devices and/or treatments. Other embodiments may be used with other types of data including polling data, survey data and the like.

### BACKGROUND

Many, if not all, pharmaceuticals and medical treatments undergo extensive safety and efficacy testing prior to their being approved for widespread use by physicians. The terminology “clinical trial” is generally utilized to refer to portions of such testing. An accepted definition of “clinical trial” is the experimental administration of new drugs or medical therapies to human patients in tightly controlled settings. Clinical trials for pharmaceuticals generally include four or more phases referred to as Phase I, Phase II, Phase III and Phase IV. In general, the number of subjects and length of time of the trial increases with each phase.

A Phase I clinical trial generally refers to a clinical trial on a few persons to determine the safety of a new drug or invasive medical device that also evaluates dosage and/or toxicity limits. A Phase II clinical trial generally refers to a clinical trial on more persons than in phase I, intended to evaluate the efficacy of a pharmaceutical, device or treatment for the condition it is intended to treat while side effects are monitored. A Phase III clinical trial generally refers to a large clinical trial of a pharmaceutical, device or treatment that in Phase I and Phase II has been shown to be efficacious with tolerable side effects. Successful completion of Phase III may result in the pharmaceutical, device or treatment receiving formal regulatory approval, for example by the US Food and Drug Administration. A Phase IV clinical trial may occur where the pharmaceutical, device or treatment is monitored by the manufacturer for effects in a patient population and/or when the pharmaceutical, device or treatment is tested with a different patient population than in an earlier phase.

During a typical trial phase I, a small number of healthy volunteers test the drug for safety and help to determine the proper dosage. The focus is on questions like how the drug is absorbed by the body, metabolized and excreted, and what is its duration of action. Phase I often lasts approximately one year. A typical phase III focuses on whether or not the drug actually works. It is used by 100 to 300 patients to study its effectiveness and any side effects, and usually lasts 2 to 3 years. Phase III focuses on side effects with a test patient base of 3,000 to 10,000. The effects of the drug over a long term, the proper dosage, and the range of side effects are the products of the analysis, and may take 3 to 4 years to complete Until very recently, the mountains of patient diary and case report form data associated with these trial phases have been collected and recorded only on paper during visits to Clinical Research Coordinators (CRCs) to obtain refills of trial medication. In addition to concerns regarding completeness and accuracy, the task of merely organizing and cleaning this data, and preparing paper reports for submission to approval bodies, is formidable. This remains a major bottleneck to progress in the development of new drugs. This is the most complex and time-consuming part of drug discovery and development. The delays incurred in the checking, re-checking, entering and transmitting of data all translate into very significant delays in analysis. The often poor quality of the data results in trial analysis that is not as trustworthy as the FDA would like. Every day of delay costs drug companies millions of dollars. Up to 30% of pharma development budgets are spent on making sure collected trial data is accurate. The number of drug trials conducted is increasing steadily, so the trials must become more efficient in their use of research budgets.

A transition to electronic data capture is underway. Electonic data capture has many advantages. The fewer number of people that handle the data, the higher likelihood that it is ‘clean’. By shortening the path from data entry to the clinical trial database, researchers can gain much faster access to data of a much higher quality. Increasingly researchers want real time access to the data so that they can react quickly to detected problems and make adjustments to the trial.

### SUMMARY OF THE INVENTION

The present invention provides systems, methods and computer readable media that enable and/or facilitate the creation, management, distribution, collection and/or analysis of data. An embodiment of a system of the present invention may include exchange of data among a host data management system and at least one client device. The exchange may comprise a real time exchange or a substantially real time exchange, as well as other protocols.

Systems and methods of the present invention have applications in many different fields where the systems and methods of the present invention provide advantages over heretofore utilized techniques for creating, managing, distributing, collecting and/or analyzing data. By way of example, embodiments of the present invention are useful in the healthcare, pharmaceutical services, consumer marketing and market testing and polling fields among others.

In one embodiment, a system of the present invention is advantageous for use in enabling and/or facilitating the creation, management, distribution, collection and/or analysis of data for a clinical trial. The clinical trial may comprise investigation of a pharmaceutical composition, a therapy, a medical device and/or combinations of the foregoing.

In one embodiment, a system of the present invention is advantageous for use in enabling and/or facilitating the creation, management, distribution, collection and/or analysis of data for determining consumer satisfaction.

In one embodiment, a system of the present invention is advantageous for use in enabling and/or facilitating the creation, management, distribution, collection and/or analysis of data relating to healthcare services.

In one embodiment, a system of the present invention is advantageous for use in enabling and/or facilitating the creation, management, distribution, collection and/or analysis of polling data, for example in surveys or political polls, including voting.

Details relating the features and advantages of embodiments of the present invention are set forth below.

### BRIEF DESCRIPTION OF THE FIGURES

Features, aspects, and advantages of the present invention are better understood when the following Detailed Description is read with reference to the accompanying drawings, wherein:

FIG. 1A depicts an environment in an embodiment of the present invention.

FIG. 1B depicts an alternate environment for an embodiment of the present invention.

FIG. 1C depicts a further possible environment for an embodiment of the present invention.

FIG. 2 depicts an embodiment of a possible system of the present invention.

FIG. 3 provides a schematic overview of a possible scheme for handling a data transmission in an embodiment of the present invention.

FIG. 4 provides a schematic overview of a possible timer architecture in an embodiment of the present invention.

### DETAILED DESCRIPTION OF THE INVENTION

The present invention provides systems, methods and computer readable media relating to data creation, collection, distribution, management and/or analysis.

In one embodiment, the present invention provides a system comprising: a host computing device capable of interacting with a wireless network; and at least one client device capable of interacting with a wireless network; wherein the host computing device and the client device exchange data via a wireless network and the data comprises at least one datum relating to a clinical trial.

Client trial data includes, but is not limited to, the following data types (with individual datum within each type of data): patient data, including datums relating to age, weight, sex, medical condition, address, phone number, email address, race/ethnic background, medical history, population, geographic location, genetic information, predisposition towards a particular disease or condition, epidemiological data and the like; patient recruitment data, including similar data as patient data; pharmaceutical data, including dosage, dose time, composition and the like; medical device data, including usage, usage time, and the like; medical therapy data, including therapy schedule, therapy time and the like; efficacy data, including objective data relating to heart rate, blood pressure, temperature and other patient physical conditions, and subjective data relating to the patient's subjective feelings of wellbeing, and the like; side effect data, including the data similar to the efficacy data; clinical affect data, including data similar to the efficacy data. The types of data to be created and collected in a system of the present invention will typically be customized based on the objectives of the clinical trial/study.

In another embodiment, the present invention provides a system comprising: a host computing device capable of interacting with a wireless network; and at least one client device capable of interacting with a wireless network; wherein the host computing device and the client device exchange data via a wireless network and the data comprises at least one datum relating to patient recruiting. Patient recruiting data may include the datum types referred to above.

In another embodiment, the present invention provides a system comprising: a host computing device capable of interacting with a wireless network; and at least one client device capable of interacting with a wireless network; wherein the host computing device and the client device exchange data via a wireless network and the data comprises at least one datum relating to patient satisfaction. Patient satisfaction data (individual datum) may include: waiting time; subjective patient feelings; scheduling data; other feedback and similar types of data generally created and generated in surveys of patient satisfaction.

In another embodiment, the present invention provides a system comprising: a host computing device capable of interacting with a wireless network; and at least one client device capable of interacting with a wireless network; wherein the host computing device and the client device exchange data via a wireless network and the data comprises at least one datum relating to a patient diary. Patient diary data generally includes the individual datum set forth above with reference to clinical trial datum.

In another embodiment, the present invention provides a system comprising: a host computing device capable of interacting with a wireless network; and at least one client device capable of interacting with a wireless network; wherein the host computing device and the client device exchange data via a wireless network and the data comprises at least one datum relating to activity compliance. Activity compliance data may include: scheduling data relating to the activity; acknowledgment data relating to completion of the activity; and the like.

In another embodiment, the present invention provides a system comprising: a host computing device capable of interacting with a wireless network; and at least one client device capable of interacting with a wireless network; wherein the host computing device and the client device exchange data via a wireless network and the data comprises at least one datum relating to a market survey. Market survey data (and individual datum) may include the types of data generally collected during a market survey, including but not limited to: price data; salary data; purchase data; location data; geographic data; feedback data; and the like.

In another embodiment, the present invention provides a system comprising: a host computing device capable of interacting with a wireless network; and at least one client device capable of interacting with a wireless network; wherein the host computing device and the client device exchange data via a wireless network and the data comprises at least one datum relating to a customer's satisfaction with a good or service. Customer satisfaction data may include objective data relating to the good or service including time, data, price, delivery data, geographic data and the like; and subjective data relating to a customer's feelings, and the like.

In another embodiment, the present invention provides a system comprising: a host computing device capable of interacting with a wireless network; and at least one client device capable of interacting with a wireless network; wherein the host computing device and the client device exchange data via a wireless network and the data comprises at least one datum relating to a poll. Polling data may include: individual identification data such as outlined above with respect to patient data; geographic data relating to the poll; poll response data; subjective data relating to the poll and the like.

In embodiments of the present invention data, and individual datum, may be created and collected through the use of survey questions and user prompts as described in more detail below. As will be appreciated by those of ordinary skill in the art of conducting clinical trials, market surveys, customer satisfaction surveys, polling surveys and similar data collection efforts, the datum listed above with reference to embodiments of the present invention is exemplary in nature, embodiments of the present invention may be advantageously utilized with other datum traditionally existing in each of these areas.

The present invention also provides methods. In general, methods of the present invention comprise steps for implementing systems of the present invention.

In one embodiment, the present invention provides a method comprising: providing a host computing device capable of interacting with a wireless network; providing at least one client device capable of interacting with a wireless network; and exchanging data between the host computing device and the client device exchange data via a wireless network, wherein the data comprises at least one datum relating to a clinical trial.

In one embodiment, the present invention provides a method comprising: providing a host computing device capable of interacting with a wireless network; providing at least one client device capable of interacting with a wireless network; and exchanging data between the host computing device and the client device exchange data via a wireless network, wherein the data comprises at least one datum relating to patient recruiting.

In one embodiment, the present invention provides a method comprising: providing a host computing device capable of interacting with a wireless network; providing at least one client device capable of interacting with a wireless network; and exchanging data between the host computing device and the client device exchange data via a wireless network, wherein the data comprises at least one datum relating to patient satisfaction.

In one embodiment, the present invention provides a method comprising: providing a host computing device capable of interacting with a wireless network; providing at least one client device capable of interacting with a wireless network; and exchanging data between the host computing device and the client device exchange data via a wireless network, wherein the data comprises at least one datum relating to a patient diary.

In one embodiment, the present invention provides a method comprising: providing a host computing device capable of interacting with a wireless network; providing at least one client device capable of interacting with a wireless network; and exchanging data between the host computing device and the client device exchange data via a wireless network, wherein the data comprises at least one datum relating to activity compliance.

In one embodiment, the present invention provides a method comprising: providing a host computing device capable of interacting with a wireless network; providing at least one client device capable of interacting with a wireless network; and exchanging data between the host computing device and the client device exchange data via a wireless network, wherein the data comprises at least one datum relating to a market survey.

In one embodiment, the present invention provides a method comprising: providing a host computing device capable of interacting with a wireless network; providing at least one client device capable of interacting with a wireless network; and exchanging data between the host computing device and the client device exchange data via a wireless network, wherein the data comprises at least one datum relating to a customer's satisfaction with a good or service

In one embodiment, the present invention provides a method comprising: providing a host computing device capable of interacting with a wireless network; providing at least one client device capable of interacting with a wireless network; and exchanging data between the host computing device and the client device exchange data via a wireless network, wherein the data comprises at least one datum relating to a poll.

The datum in an embodiment of a method of the present invention may be the same as the datum set forth above with reference to embodiments of a system of the present invention.

The present invention further provides computer readable media. Computer readable media of the present invention comprises virtual or physical computer readable media described below containing program instructions for performing a method of the present invention, and/or for use in a system of the present invention.

In one embodiment, the present invention provides a computer readable medium on which is encoded a program code, the program code comprising: program code for providing a host computing device capable of interacting with a wireless network; program code for providing at least one client device capable of interacting with a wireless network; and program code enabling the exchange of data between the host computing device and the client device exchange data via a wireless network, wherein the data comprises at least one datum relating to a clinical trial.

In one embodiment, the present invention provides a computer readable medium on which is encoded a program code, the program code comprising: program code for providing a host computing device capable of interacting with a wireless network; program code for providing at least one client device capable of interacting with a wireless network; and program code enabling the exchange of data between the host computing device and the client device exchange data via a wireless network, wherein the data comprises at least one datum relating to patient recruiting.

In one embodiment, the present invention provides a computer readable medium on which is encoded a program code, the program code comprising: program code for providing a host computing device capable of interacting with a wireless network; program code for providing at least one client device capable of interacting with a wireless network; and program code enabling the exchange of data between the host computing device and the client device exchange data via a wireless network, wherein the data comprises at least one datum relating to patient satisfaction.

In one embodiment, the present invention provides a computer readable medium on which is encoded a program code, the program code comprising: program code for providing a host computing device capable of interacting with a wireless network; program code for providing at least one client device capable of interacting with a wireless network; and program code enabling the exchange of data between the host computing device and the client device exchange data via a wireless network, wherein the data comprises at least one datum relating to a patient diary.

In one embodiment, the present invention provides a computer readable medium on which is encoded a program code, the program code comprising: program code for providing a host computing device capable of interacting with a wireless network; program code for providing at least one client device capable of interacting with a wireless network; and program code enabling the exchange of data between the host computing device and the client device exchange data via a wireless network, wherein the data comprises at least one datum relating to activity compliance.

In one embodiment, the present invention provides a computer readable medium on which is encoded a program code, the program code comprising: program code for providing a host computing device capable of interacting with a wireless network; program code for providing at least one client device capable of interacting with a wireless network; and program code enabling the exchange of data between the host computing device and the client device exchange data via a wireless network, wherein the data comprises at least one datum relating to a market survey.

In one embodiment, the present invention provides a computer readable medium on which is encoded a program code, the program code comprising: program code for providing a host computing device capable of interacting with a wireless network; program code for providing at least one client device capable of interacting with a wireless network; and program code enabling the exchange of data between the host computing device and the client device exchange data via a wireless network, wherein the data comprises at least one datum relating to a customer's satisfaction with a good or service.

In one embodiment, the present invention provides a computer readable medium on which is encoded a program code, the program code comprising: program code for providing a host computing device capable of interacting with a wireless network; program code for providing at least one client device capable of interacting with a wireless network; and program code enabling the exchange of data between the host computing device and the client device exchange data via a wireless network, wherein the data comprises at least one datum relating to a poll.

The datum in an embodiment of a computer readable medium of the present invention may be the same as the datum set forth above with reference to embodiments of a system of the present invention.

Embodiments of the present invention are particularly advantageous for use in clinical trial settings. In one embodiment, the present invention provides a system that complies with applicable governmental regulations (21 CFR 11 in the US) to track patient data including diaries, medication and activity compliance.

In addition to the advantages provided by the present invention when used during ongoing clinical trials, in one embodiment the present invention provides a patient recruiting system to recruit potential subjects for clinical trials. In an embodiment the present invention provides a system that allows rapid access and reach for and to various patient groups/categories. This advantageously allows a perspective sponsor of a clinical trial to collect data, for example from a filtering survey, from a pool of candidates and use the data to identify the potential candidates for the clinical trial.

In one further embodiment, the present invention provides systems and methods to design and deploy patient diaries for market based data collection including looking at additional beneficial effects and longer-term adverse effects, such as during the conduct of a Phase IV clinical trial.

While not limited to these specific examples, with respect to healthcare, embodiments of the present invention may be advantageous for use with data relating to patient satisfaction, patient diaries for general research, disease management, program management and general medication compliance, homecare and related services.

By way of example, patient satisfaction may involve deployment and data collection for patients that have passed through a healthcare facility including the design and deployment of a survey to measure and collect data on factors such as, level of care, efficiency, primary care provider satisfaction and the like. In this embodiment, a system of the present invention may comprise a host data management system and one or more client devices. The client devices may be utilized by patients over a set period of time and/or substantially continuously.

As an example, patient diaries for general research may involve creation of patient diaries for study participants to gather data used by researchers, for example in an NIH sponsored study through a research facility.

An example of a disease management embodiment involves creation of a patient diary for the collection of data relating to a specific disease condition. The patient diary may include customized medication reminders and activity tracking.

Continuing in the healthcare field, program management and general medication compliance may involve systems of the present invention designed to provide tracking of patient data after release for cardio, asthma, orthopedic rehabilitation and/or similar medical therapies. General medication compliance tracking can be provided through reminders and confirmations.

Home healthcare services are provided by caregivers that perform specific services for individuals they are visiting. In a system of the present invention, client devices may comprise a “checklist” of activities to provide feedback, for example “real-time” feedback, as well as collection and tracking of basic data relating to the individual's health. Data collected may be made available to a health care provider responsible for monitoring the patient. Also, maintenance requests can be relayed on to the appropriate vendor.

Embodiments of the present invention are also advantageous for use in the consumer marketing/market testing area. By way of example, one embodiment of the present invention may be utilized to provide a customer satisfaction survey, for example an in-store customer service/satisfaction survey. The systems of the present invention provide a rapidly deployable service that can obtain customer experience data rapidly, anywhere in the country thereby providing marketing and store management with valuable rapid feedback regarding, service, products, effectiveness of campaigns etc.

In another embodiment of the present invention may provide product evaluation surveys. Currently, consumer testing and market acceptance surveys for products such as sunscreen or detergent are often distributed for evaluation by field testers. In a system of the present invention, client devices can be distributed with the product and will provide immediate and/or rapid feedback for product managers to review.

Further details relating to the present invention are described with reference to the appended figures in which like numerals indicate like elements throughout the several figures. For illustration purposes, an embodiment of a system of the present invention is described with reference to a wireless communications system, particular host computing and client devices and clinical trial data. As set forth above, and herein, systems and methods of the present invention are not limited to use in a clinical trial setting. Rather, systems and methods of the present invention have many other potential applications.

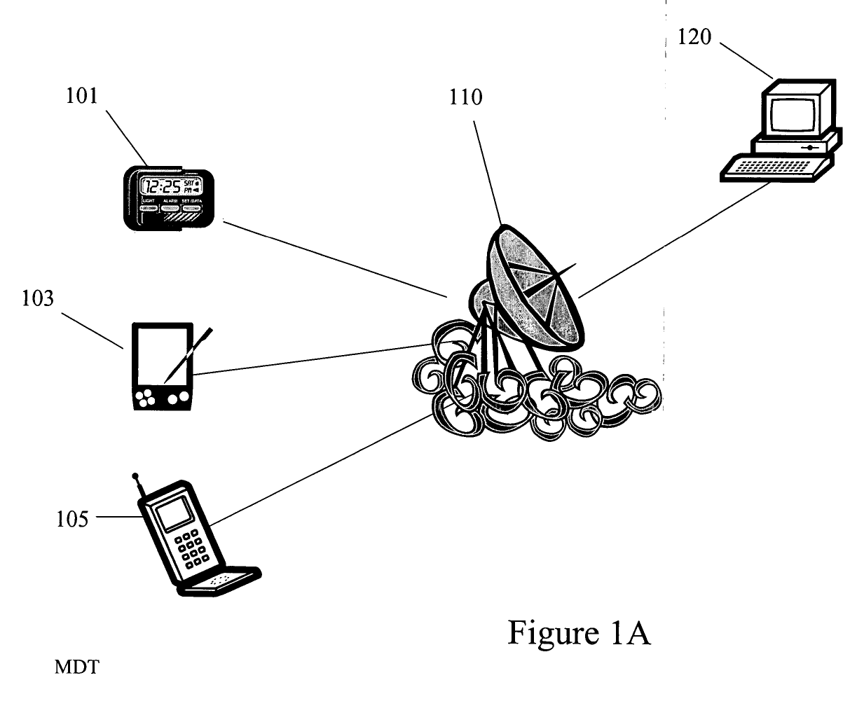

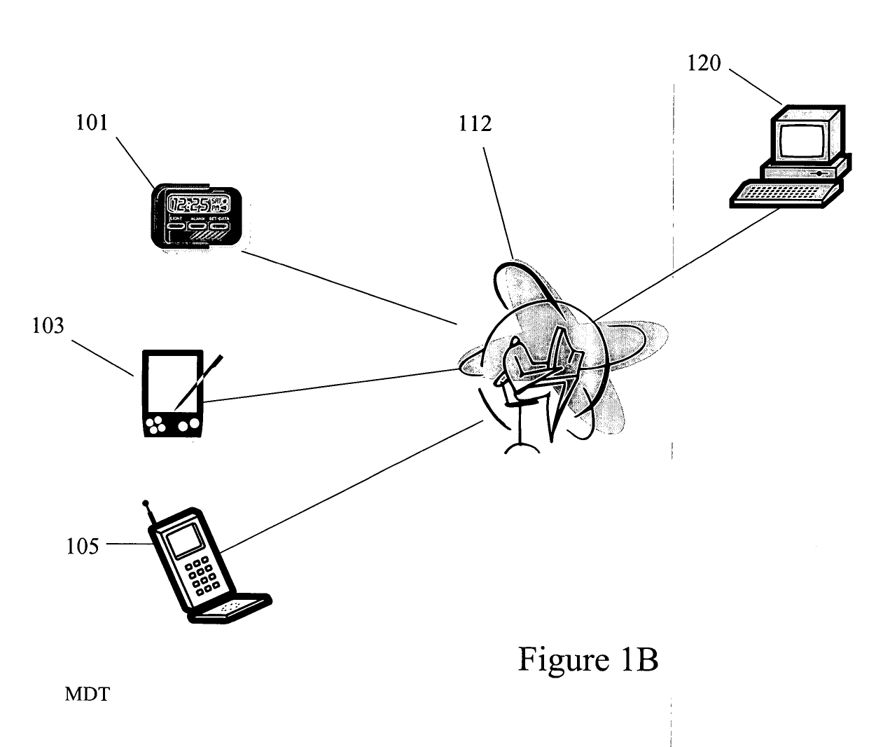

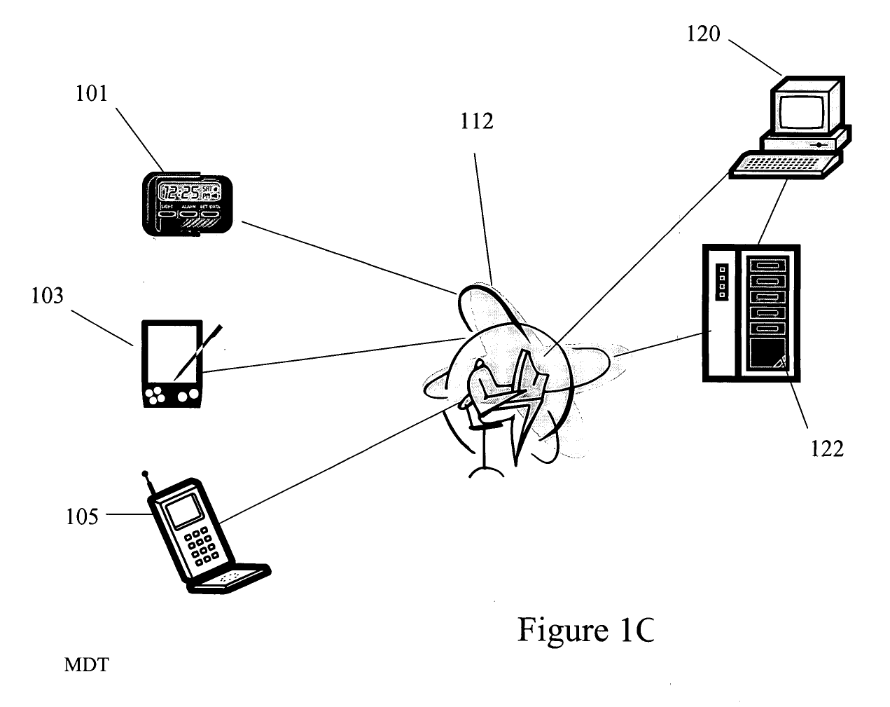

FIG. 1A is a block diagram illustrating an exemplary environment for implementation of an embodiment of the present invention. As shown in FIG. 1A, in an embodiment a system of the present invention may comprise a plurality of client devices, 101, 103 and 105, capable of communicating through a wireless network, 110, with a host computing device, 120. Each connection may independently comprise a wireless telephone link, a pager link, a wireless network connection, for example through an 802.11 protocol or similar connections.

FIG. 1B is a block diagram illustrating another exemplary environment for implementation of an embodiment of the present invention. As shown in FIG. 1B, the client devices and host computing device in a system of the present invention may communicate through the internet 112. Each connection may independently comprise a dial-up connection, for example through a modem and a wired or wireless telephone link; a broadband connection, for example through a T-1 line, cable modem, ADSL line and modem; a wireless network connection, for example through an 802.11 protocol, Bluetooth or the like; or any other method of connecting to the Internet. The individual client devices may communicate with the host computing device using telecommunications protocol via the Internet.

Many different types of client devices and host computing devices may be utilized in systems and methods of the present invention. Suitable client devices and host computing devices include devices capable of sending and/or receiving email transmissions; electronic pages; and/or transmitting data via network connections. Generally, a client device or a host computing device includes a computer-readable medium, for example a random access memory (RAM), coupled to a processor. The processor executes computer-executable program instructions stored in memory. Such processors may include a microprocessor, an ASIC, state machines, or other processor, and can be any of a number of computer processors, such as processors from Intel Corporation of Santa Clara, Calif., IBM Corporation of Raleigh, N.C. and Motorola Corporation of Schaumburg, Ill. Such processors include, or may be in communication with, media, for example computer-readable media, which stores instructions that, when executed by the processor, cause the processor to perform the steps described herein. Embodiments of computer-readable media include, but are not limited to, an electronic, optical, magnetic, or other storage or transmission device capable of providing a processor, such as the processor of the client device with computer-readable instructions. Other examples of suitable media include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. The instructions may comprise code from any computer-programming language, including, for example, C, C++, C#, Visual Basic, Java, Python, Perl, and JavaScript.

Client devices and/or host computing devices may also include a number of external or internal devices such as a mouse, a CD-ROM, DVD, a keyboard, a display, or other input or output devices. Examples of client devices and/or host computing devices are personal computers, digital assistants, personal digital assistants, cellular phones, mobile phones, smart phones, pagers, digital tablets, laptop computers, Internet appliances, and other processor-based devices. In general, the client computing devices may be any type of suitable processor-based platform that operates on any suitable operating system, such as Microsoft Windows®, PocketPC, Palm, Apple OS, UNIX, JAVA, EPOCH, Linux or the like, capable of supporting one or more client application programs. For example, the client computing device shown comprises a pager executing client application programs, also known as client applications. The client applications can be contained in memory and can, for example, include, in addition to an application specific to the present invention, an e-mail application, an instant messenger application, an Internet browser application, a calendar/organizer application, and any other application capable of being executed by a client device.

FIG. 1C depicts a further alternate environment for a system of the present invention. As shown in FIG. 1C, the environment may further include server computing device, 122. In this type of embodiment a software application may run on the server computing device, 122 and be accessed by the host computing device and/or client devices. The host computing device and client device may be part of a network with server computing device, 122 and/or communicate with server computing device 122 via the internet utilizing a communications protocol.

The server computing device 122 may include a processor coupled to a computer-readable memory and a communications device. Server computing device 122, depicted as a single computer system, may be implemented as a network of computer processors. Examples of a server computing device 122 are servers, mainframe computers, networked computers, a processor-based device, and similar types of systems and devices. The server processor can be any of a number of computer processors, such as processors from Intel Corporation of Santa Clara, Calif. and Motorola Corporation of Schaumburg, Ill.

The server computing device memory may include any of the processors described below with reference to computing devices, client devices and a method of the present invention.

It should be noted that the present invention may comprise systems having different architecture than that which is shown in FIGS. 1A, 1B and 1C. For example, in some systems according to the present invention, server device may comprise a single physical or logical server. The system shown and described is merely exemplary, and is used to explain the exemplary methods described below and depicted in part in the remaining Figures. Further, embodiments of the present invention may operate on individual, non-networked computing devices wherein data is transferred between host computing devices and client devices utilizing telecommunication networks.

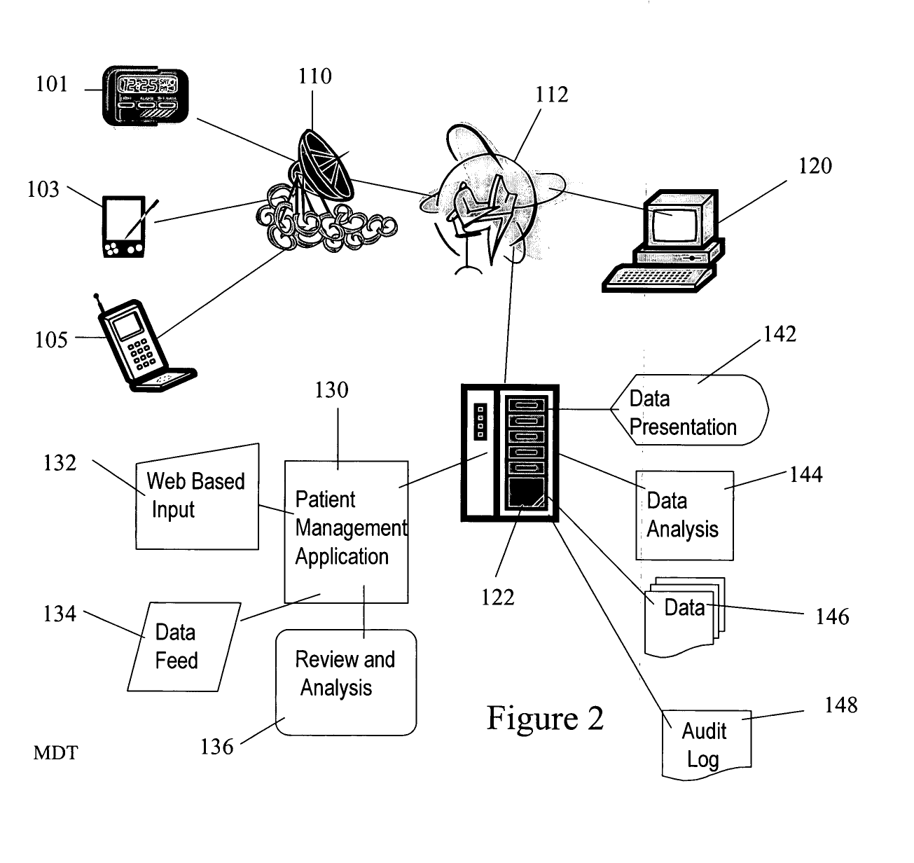

FIG. 2 depicts a possible architecture for an embodiment of the present invention for use in a healthcare application. In the embodiment shown in FIG. 2 access to internet 112 by host computing device 120 may be provided by a service provider and software applications implementing the present invention may operate in an ASP model on server 122. Client devices 101, 103 and 105 may access the internet through a wireless logistics provider, 112, such as a provider of paging or cellular telephone service.

Patient management application, 130 may provide web based input, 132, data feed, 134 and review and analysis 136 functions. Patient management application may also provide data presentation, 142, data analysis 144 and audit log 148 functions through server 122. Data 146 may also be stored and accessed through server 122. Data may include, for example, sponsor data, patient data and the like. Patient management application, 130, may be accessed by computing device 120 through the web.

In further detail, in one embodiment a system of the present invention may be utilized in medical studies, clinical trials and other patient management processes in the healthcare industry. These processes involves a specific set of patients and their related supporting practitioners who collect information on a regular basis over a specified period of time. A participant in a clinical trial or study would be assigned a two-way pager or similar wireless client device such as a cellular telephone or Blackberry device. The two-way pager would be a “client” of a “host” data management system and is enabled with a custom resident software application to receive and send patient data at a point in time, variable over time, via a page or other data transfer method. The custom resident software will enable the client device to recognize and format a series of survey or diary questions and other relevant information, including drug schedule and reminders, activity schedules and reminders, for use by the patient or practitioner. The survey information and other related information is exchanged between a host data management system and the client device via a page or other transfer method.

In one embodiment, a client device, such as a two-way pager, serves as a primary tool for the capture and ongoing tracking of patient or practitioner diary and medication compliance (study/clinical trial data), and as a storage device for information for the patient to participate in the study/clinical trial. This stored information may include, medication schedules and reminders, patient appointments and reminders, contacts and other information that could assist the patient or practitioner.

The invention may have application in other areas or industries where a remote survey capability using a two-way pager or other mobile wireless device connectable to the server could be used to rapidly collect and process responses such as patient management (outside the context of a clinical trial), patient recruitment for clinical trials, patient satisfaction measurement, consumer surveys, customer satisfaction surverys, marketing surveys, product testing surveys, group surveys or voting and polling, inspections or in similar applications wherein a mobile data collection device and a system of the present invention provides the capability to rapidly collect and analyze responses from an individual or series of individuals at a moment in time, variable over time.

In one embodiment a system of the present invention includes a host data management system that may reside on a server and/or a host computing device. The data management system may be web based in an ASP model and be accessed by a host computing device.

a host data management system in one embodiment of the present invention includes software applications that provide administrative capabilities and a data base to create, distribute, and manage surveys and diaries, medication schedules, and other information that are distributed, via pages or other transfer method, to a specified group of patients or practitioners who are utilizing two-way pagers or other wireless mobile device. These capabilities provided by a software application include, but are not limited to:

an interface and functionality with which a user may develop individual and group participant information profiles and store them on the host for a clinical trial or other patient oriented study;

an interface that allows for a password to be set for each individual or group;

an interface that allows for an encryption key to set for data exchange;

an interface and functionality to format and store a set of questions, “a survey”, and with each question assigned a set of potential responses to the question (i.e. multiple choice format) or allow for “free form” response to the question;

an interface and functionality to analyze and present the survey responses, and other interactions, of both individuals and the group at a point in time, over time;

an interface and functionality to generate individual or group schedules, reminders, medication protocols and other instructions or information related to the clinical trial or study. The interface provides the ability to set multiple occurrences or reminders that require a timed, recorded response related to a diary or medication schedule;

an interface and functionality to provide an audit function that records the transmission of pages from the host data management system, confirms receipt of the transmitted data by a confirmation page (returned by each pager) and matching process, and monitors the usage and time of responses from each individual pager; and/or

Functionality to enable the systematic receipt of responses (i.e. survey responses and other interactions) via page(s) generated by the custom application on the two-way pagers at a point in time and/or over time.

In one embodiment a system of the present invention also includes application integration between and/or among the host data management system and other existing information management systems via Application program interfaces (APIs), standard Open Data Base Connection (ODBC) capability and other software based conversion and transfer methods such as XML. The host data management system would utilize integration to interact with other data collection systems and with logistics systems that would be utilized to manage the configuration and distribution of devices to patients.

As set forth above, in one embodiment data capture may be performed primarily using a two-way pager or other programmable wireless device, and transmission primarily through a page(s). Other methods may be used to capture and transmit data to the host. IN an embodiment, email transmission may be used to transmit data between a client device and a host computing device and/or server.

In one embodiment, a system of the present invention may further include a software application to perform conversion or translation of the survey to the native language of a participant or group of participants. This would be performed through the identification of the native language of the participant or practitioner and would utilize a software application to perform language conversion or translation of the survey and related information.

In an embodiment of the present invention similar to the embodiment depicted in FIG. 2, a host data management system and a two-way pager communicate via a page or connection of the two-way pager or mobile device to an internet connected computer or other internet connected hardware device. The host application may have the ability to utilize a data encryption mechanism for any data exchanged between the two devices. This process includes using the internet and posting a formatted set(s) of data hyper text mark-up language (HTML) to a specific website (paging provider) to initiate a page or pages, or using simple network paging protocol (SNPP) to initiate the paging process.

In one embodiment of the present invention, a client device comprises a software application. The resident software application may be specifically designed to interpret the incoming page(s), configure the diary question sets, and administer the survey through an interface. The resident software on the client device may also provide the user of the device, e.g. the patient or practitioner. with additional information and interaction such as schedules, medication timer, instructions and prescribed protocols and other related information through the user interface. The client device resident software may also enable the device to record, format and then transmit the responses to the survey questions, medication schedules, and other interactions via a communications link such as a page or email. A timer function may be utilized to verify the timely responses to requested information.

The client device software will generally be designed according to the operating system of the client device and the client device software of the present invention will interact with and use features, for example alarm features, incorporated within the operating system of the client device. In one embodiment, the client device software of the present invention will also interact with the operating system of the client device to access storage on the client device to provide the capability for the receipt and storage of the survey or patient diary questions, medication schedules and other related data. This stored data would typically be held in table format.

In one embodiment, the client device software in a system of the present invention provides the user of the client device with an individualized set of questions at a specified times, based on the study. The interface allows the user to select, or compose a response to each question presented and store that response for transmission back to the host. The software may also provide a mechanism to interact with other related information such as medication schedules, reminders, instructions and other information relevant to the patient or practitioner's participation in the clinical trial.

In one embodiment, survey responses and other patient related data may be transmitted from the client device, for example via page or email from a two-way pager, by patient “self” initiation, by automatic initiation at a specified interval programmed in the resident software, and/or in response to a transmission from a host computing device. The responses may be measured for timeliness based on a criteria set on the host system.

In one embodiment stored data may be updated on the client device at a specified interval or on an “ad hoc” basis through the initiation and receipt of a transmission from a host computing device.

In one embodiment security measures are provided to ensure the integrity of data and the authority of users. These measures would be applied to the client device and/or the “host” data management system. Security measures may include password logins or entry codes or digital certificates or other methods depending on the requirements of the implementation. For example, a password interface may be provided on the client device that requires that a user enter a specific password to utilize the device interface.

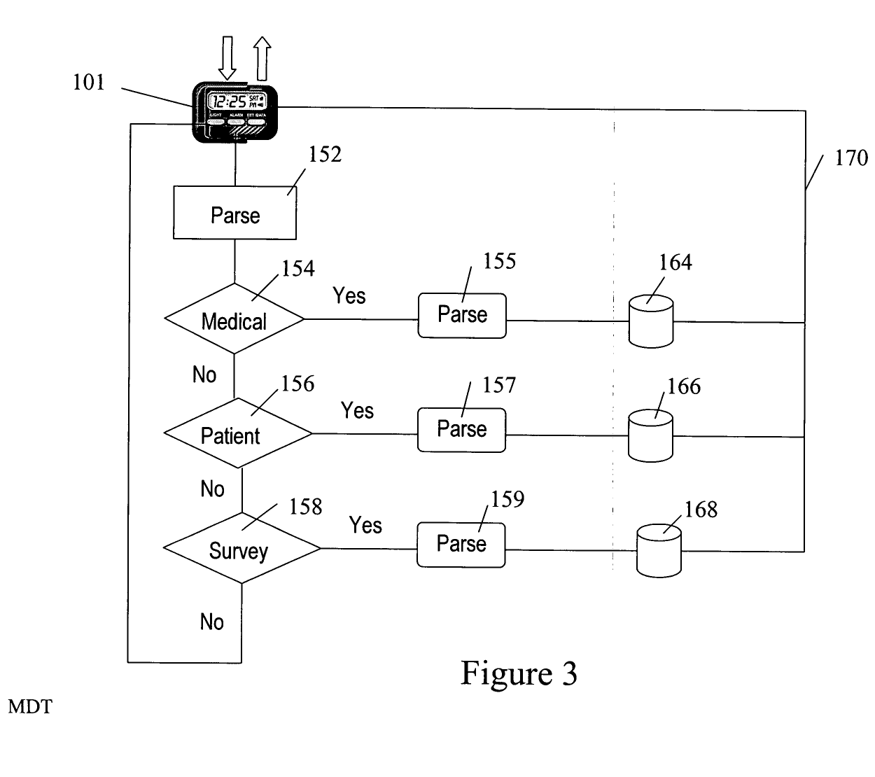

As set forth herein, in one embodiment of a system of the present invention, a host computing device communicates with a client device to exchange data relating to a clinical trial for a pharmaceutical, medical device and/or treatment regime. FIG. 3 provides a schematic illustration of a possible architecture in a client device for handling a data transmission.

As shown in FIG. 3, a client device, 101 receives an electronic transmission, for example using a email protocol. The transmission is parsed and processed 152 to determine whether it contains medical data, 154, patient related data, 156, and/or survey data, 158. If the transmission includes medical data the data is processed 155 and appropriate fields of a medical data database 164 are updated. Similarly, if the transmission includes patient related data the data is processed 157 and appropriate fields of a medical data database 166 are updated. If the transmission includes survey data the data is processed 159 and appropriate fields of a medical data database 168 are updated. A confirmation of receipt and update of the appropriate fields may be generated and transmitted back, 170 to the host computing system. If the transmission does not contain any of the foregoing data types, or in other embodiments of the present invention, other data types utilized by a system of the present invention, the client device processes the transmission according to other software resident on the client device.

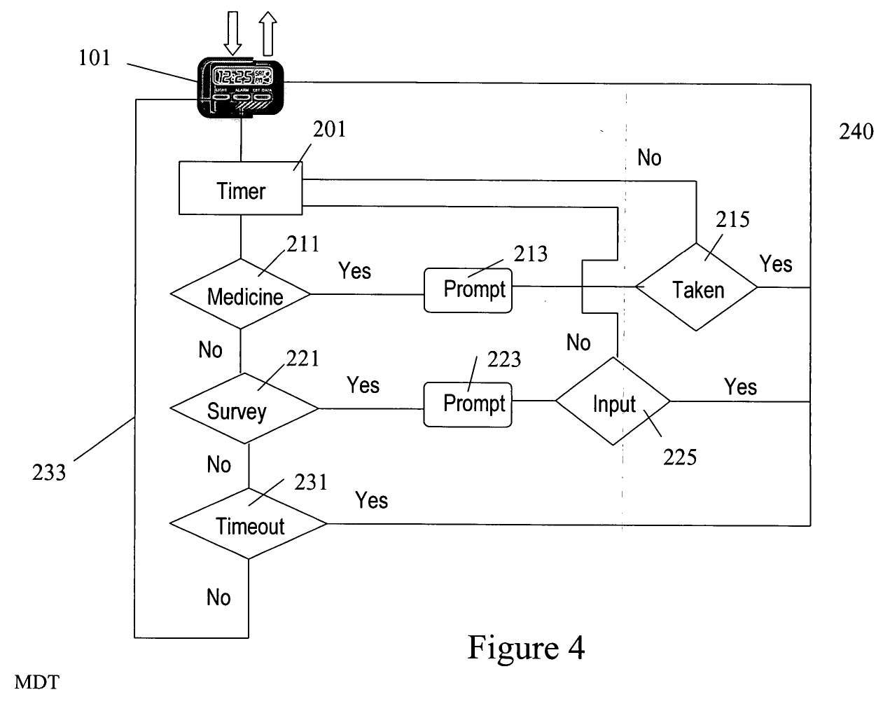

One datum useful in clinical trials is the time at which a pharmaceutical is to be taken by a patient. The architecture depicted in FIG. 3 is an example of an architecture in a system of the present invention that may be utilized to provide a client device with data relating to the time at which a pharmaceutical is to be taken or administered, and the amount to be taken and the like. The client device may also include other timers that prompt a user/study participant to take different actions necessitated by the study. FIG. 4 provides a schematic overview of a possible timer embodiment.

As shown in FIG. 4, client device 101, may be configured with timer functionality, 201 to provide reminders for events such as time for medicine, 211, time to complete a survey question or questions 221, and the like. Should the timer function determine that it is time for the user to take a medicine, a user prompt, 213 may be generated. If the patient/user responds to the prompt, for example by indicating the medicine has been taken, an email 240 may be generated to a host computing device to provide data on the medicine being taken, the time, and similar types of data. If the user does not respond to the prompt after a fixed period of time, the timer function is notified and the prompt is repeated.

Similarly, should the timer function determine that it is time for the user/patient to take a survey, 221, for example after a fixed time has elapsed after taking a medicine. A user prompt, 223 is generated requesting the user respond to a survey question or questions. If the patient/user responds to the prompt, for example by answering a survey question, an email 240 may be generated to a host computing device to provide data from the survey, acknowledge the response, or provide related details. If the user does not respond to the prompt after a fixed period of time, the timer function is notified and the prompt is repeated.

The timer function may also prompt other reminders, for example physician appointments, in similar manners. Should a prompt or prompts not be responded to in a fixed period of time, the timer function may process a timeout, 231 and generate an email 240 to a host computing device with data indicating that a specified action was not completed at the programmed time.

As will be appreciated based on the description herein, a client device in an embodiment of the present invention may be provided with functionality based on the desired end use application. A feature of one embodiment of the present invention is that client device applications may be designed to operate with minimal impact to memory and processor resources of the client device. Processing of data may be provided by a host computing device and/or host server.

Systems of the present invention may advantageously use the internet/world wide web to provide a web based system for gathering, managing, distributing, processing and analyzing data. In this type of embodiment, a system of the present invention may comprise a web based software application, running for example on an ASP server, that is accessed by a host computing device. The web based software may comprise a management console that enables a user to organize a study, collect data, transmit and receive data from client devices and perform other functions. In a possible process flow, a study administrator could initiate a study by creating a study file, creating study questions, adding study participants, and adding the medicines or activities that will be investigated. Client devices may be provided with an application allowing a client device to interact and exchange data relating to the study. The study may be monitored on an ongoing basis from the web based software application.

The foregoing description of exemplary embodiments of the invention has been presented only for the purpose of illustration and description and is not intended to be exhaustive or to limit the invention to the embodiments disclosed. Numerous modifications and adaptations thereof will be apparent to those skilled in the art without departing from the spirit and scope of the present invention.

It should further be appreciated that reference throughout to “one embodiment” or “an embodiment” of the invention do not necessarily imply that the same embodiment is being referenced or that a particular feature is necessarily included in any other embodiment. Each claim, as may be amended from time to time, is hereby incorporated by reference into this description as one embodiment of the invention.

1. A system comprising: a host computing device capable of interacting with a wireless network; and at least one client device capable of interacting with a wireless network; wherein the host computing device and the client device exchange data via a wireless network and the data comprises at least one datum relating to a clinical trial.

2. The system of claim 1 wherein the data comprises a datum from at least one of the following data types: patient data; patient recruitment data; pharmaceutical data; medical device data; medical therapy data; efficacy data; side effect data; and/or clinical affect data.

3. The system of claim 2 wherein the data is collected via a survey.

4. The system of claim 3 wherein the survey is provided on the client device and the data is collected by the host computing device through the wireless network.

5. The system of claim 4 wherein the wireless network comprises the internet.

6. The system of claim 5 wherein the wireless exchange comprises an email.

7. A system comprising: a host computing device capable of interacting with a wireless network; and at least one client device capable of interacting with a wireless network; wherein the host computing device and the client device exchange data via a wireless network and the data comprises at least one datum relating to at least one of the following: patient satisfaction; a patient diary; patient recruitment; and/or activity compliance.

8. The system of claim 7 wherein the data is collected via a survey.

9. The system of claim 8 wherein the survey is provided on the client device and the data is collected by the host computing device through the wireless network.

10. The system of claim 9 wherein the wireless network comprises the internet.

11. The system of claim 10 wherein the wireless exchange comprises an email.

12. A system comprising: a host computing device capable of interacting with a wireless network; and at least one client device capable of interacting with a wireless network; wherein the host computing device and the client device exchange data via a wireless network and the data comprises at least one datum relating to at least one of the following: a market survey and/or customer satisfaction with a good or service.

13. The system of claim 13 wherein the data is collected via a survey.

14. The system of claim 13 wherein the survey is provided on the client device and the data is collected by the host computing device through the wireless network.

15. A system comprising: a host computing device capable of interacting with a wireless network; and at least one client device capable of interacting with a wireless network; wherein the host computing device and the client device exchange data via a wireless network and the data comprises at least one datum relating to a poll.

16. The system of claim 15 wherein the data is collected via a survey.

17. The system of claim 16 wherein the survey is provided on the client device and the data is collected by the host computing device through the wireless network.

18. A method comprising: providing a host computing device capable of interacting with a wireless network; providing at least one client device capable of interacting with a wireless network; and exchanging data between the host computing device and the client device exchange data via a wireless network, wherein the data comprises at least one datum relating to a clinical trial.

19. The method of claim 19 wherein the method further comprises providing a survey to the client device to generate data for exchange.

20. A computer readable medium on which is encoded a program code, the program code comprising: program code for providing a host computing device capable of interacting with a wireless network; program code for providing at least one client device capable of interacting with a wireless network; and program code enabling the exchange of data between the host computing device and the client device exchange data via a wireless network, wherein the data comprises at least one datum relating to a clinical trial.
